(19) United States
(12) Patent Application Publication
(10) Pub. No.: US 2016/0290284 A1
(43) Pub. Date: Oct. 6, 2016

(54) A DEVICE FOR FEEDING A ROCKET ENGINE PROPULSION CHAMBER WITH PROPELLANT

(71) Applicant: SNECMA, Paris (FR)

(72) Inventors: Antoine CARATGE, Marnes la Coquette (FR); Gérard ROZ, Pressagny I'Orgueilleux (FR)

(73) Assignee: SNECMA, Paris (FR)

(21) Appl. No.: 15/037,780

(22) PCT Filed: Nov. 14, 2014
(86) PCT No.: PCT/FR2014/052909

§ 371 Date: May 19, 2016

(30) Foreign Application Priority Data
Nov. 22, 2013 (FR) 1361508

(51) Int. Cl. F02K 9/50; F02K 9/58

(52) U.S. Cl. CPC F02K 9/50; F02K 9/58

(57) ABSTRACT

A feed device (20) for feeding propellant to at least one rocket engine propulsion chamber (19) of a propulsion assembly (21) comprises a main propellant tank (1, 2), and a main feed pipe (3, 4) extending between the main tank (1, 2) and the propulsion chamber (19) and having a main feed valve (VAH, VAO) placed thereon. The feed device further comprises an auxiliary tank (11, 12) for said propellant and an auxiliary feed pipe (13, 14) provided with an auxiliary feed valve (VH1, VO1) connecting the auxiliary tank (11, 12) to the main feed pipe (3, 4) downstream from the main feed valve (VAH, VAO).

### FIELD OF THE INVENTION

The present description relates to a space propulsion assembly, and more particularly to a device in such a propulsion assembly for feeding a rocket engine propulsion chamber with propellant.

### BACKGROUND

Because of its accumulation over space missions, debris left in space has become a significant impediment for present missions. In particular, such debris can be dangerous for new satellites put into orbit around the earth. That is why it is now required that a launcher no longer generates any debris, at least in the two zones that are critical for satellites: low orbit (in the range 160 kilometers (km) to 2000 km above the surface of the earth), and geostationary orbit (35,786±200 km above the surface of the earth and within ±15° about the equator). One of the main pieces of debris from a launcher is the top stage of the launcher itself. Thus, after putting a satellite into orbit, a top stage needs to be able to leave the critical zone in which it is to be found (when this is the case) and never return thereto. By way of example, this can be done by imparting a speed increment to the top stage; this increment may be obtained either by means of the engine of the stage or by means of an associated system.

When releasing a satellite, the top stage is generally on a ballistic trajectory, i.e. the rocket engine of the top stage has been shut down. The main propellant tanks that feed propellant to the rocket engine are at low pressure. In addition, it can happen that heat is exchanged between the main propellant tanks, particularly if there is a common wall between them. For example, with cryogenic propellants, e.g. the liquid hydrogen (LH₂) and liquid oxygen (LOx) pair, since liquid hydrogen is at a lower temperature than liquid oxygen, the hydrogen is heated while the oxygen is cooled. In particular, some of the hydrogen may vaporize, thereby leading to an increase in pressure in the main hydrogen tank. In order to compensate for this vaporization, de-gassing is performed, i.e. vaporized hydrogen is voluntarily released in order to reduce the pressure and the temperature in the main liquid hydrogen tank. In parallel, some of the oxygen may cool down considerably (and possibly even freeze locally), which is harmful for stable operation of the engine. In order to avoid this phenomenon, it is possible for example to provide surplus liquid hydrogen so as to increase the thermal inertia of the oxygen and thus slow down its cooling. This surplus oxygen is not consumed during the mission, and thus forms part of the inert weight of the top stage, directly to the detriment of the payload of the launcher.

Furthermore, the propellants contained in the main tanks are heated under the effect of solar radiation. Nevertheless, with main LOx and LH₂ tanks sharing a common wall, the extent to which the oxygen is heated is often less than the extent to which it is cooled as a result of transferring heat to the hydrogen.

After the satellite has been released, the top stage needs to de-orbit. In order to impart a speed increment, it is known to use the rocket engine of the top stage itself, operating in nominal manner with its pump. Restarting the engine requires the propellant tanks to be re-pressurized and settled. Settling is an acceleration operation seeking to cause the liquid propellant to be pressed against the bottom of the tank, i.e. against the wall of the main tank where it has its connection with the main feed pipe, so that the fluid flowing in the main feed pipe after a period of microgravity is indeed mainly liquid propellant and not low density gaseous propellant possibly mixed with an inert pressurizer fluid. Settling and pressurizing the main tank enables the main feed pipes to be cooled down together with the pumps and all of the pipes in which the propellants flow between the main tanks and the propulsion chamber. Cooling down is generally performed by causing a small amount of propellant to flow into the engine under the force coming from the acceleration delivered to the stage. Said propellants are then ejected through specific purge valves. Thereafter the engine is restarted in nominal mode and can deliver the speed increment necessary for de-orbiting.

Thus, a device for feeding propellant to at least one rocket engine propulsion chamber in the state of the art comprises a main propellant tank, and a main feed pipe extending between the main tank and the propulsion chamber, and having a main feed valve placed thereon.

Nevertheless, such a system presents numerous drawbacks. Firstly, it requires the pressurizer system of the stage to be overdimensioned so as to be capable of re-pressurizing a main tank of large capacity and starting from an initial pressure that is very low. The capacity of a tank is the volume that the tank can contain. When re-pressurizing is performed by injecting helium into the main tank, the system requires a relatively large weight of helium to be on board, and to make matters worse, a portion of it cannot be consumed (in particular when storing helium in gaseous form), so a large storage system is thus required, which is very expensive in terms of weight and which correspondingly decreases the payload of the launcher. Furthermore, the above-described de-orbiting system normally also requires a dedicated external settling kit in order to be able to restart the rocket engine.

Finally, the propellant consumption necessary for de-orbiting can be problematic. When using the above-mentioned LH₂/LOx pair, it is essential to consume the propellant as soon as possible in order firstly to limit evaporation of the hydrogen (since gaseous hydrogen can no longer be used), and secondly to limit cooling of the oxygen (since the surplus oxygen provided for limiting cooling is not consumed). These reasons lead to performing the de-orbiting maneuver as soon as possible. Unfortunately, from a ballistic point of view, it would often be preferable to wait several hours before performing the de-orbiting maneuver so as to greatly increase its effectiveness, but this is not possible because of the above-mentioned heat exchanges. Thus, the de-orbiting maneuver, which is performed too soon from an energy point of view, turns out to be expensive in propellants, leading to a weight penalty for the payload of the launcher.

There thus exists a need for a novel type of device for feeding a rocket engine with propellant.

### SUMMARY OF THE INVENTION

The present description provides a feed device for feeding at least one rocket engine propulsion chamber with propellant, the feed device comprising a main propellant tank, a main feed pipe extending between the main tank and the propulsion chamber, and having a main feed valve placed thereon, the feed device being characterized in that it further comprises an auxiliary tank for said propellant and an auxiliary feed pipe provided with an auxiliary feed valve connecting the auxiliary tank to the main feed pipe downstream from the main feed valve.

In the present description, unless specified to the contrary, the terms “upstream” and “downstream” are used relative to the normal flow direction of the propellant, in particular from the tanks to the propulsion chamber. Thus, saying that the auxiliary feed pipe connects the auxiliary tank to the main feed pipe downstream from the main feed valve means that the propellant coming from the auxiliary tank can flow to the propulsion chamber via the auxiliary feed pipe and then via the main feed pipe without passing through the main feed valve.

The auxiliary tank thus enables the propulsion chamber to be fed with said propellant independently from the main tank. This feed can lead to a speed increment. Thus, the auxiliary feed valve can remain closed until the auxiliary tank is used, such that at the time it is used the auxiliary tank is still at its initial filling level and under a pressure close to its filling pressure. Merely opening the auxiliary feed valve thus enables the propellant contained in the auxiliary tank to flow towards the propulsion chamber. Should it be useful, the auxiliary tank can be pressurized simply, while consuming little pressurizer fluid, insofar as the auxiliary tank is at its initial filling level when it begins to be used. Thus, feeding the rocket engine with propellant from the auxiliary tank does not require provision to be made for the pressurizer system of the feed device to be overdimensioned.

The auxiliary tank enables the rocket engine to operate in a low intensity mode known as “idle” mode, i.e. in a mode in which the pumps feeding the propulsion chamber with propellant are stopped and the propellant is caused to flow to the propulsion chamber mainly under the effect of a pressure difference between the auxiliary tank and the propulsion chamber. This pressure difference may be maintained by pressurizing the auxiliary tank progressively as the propellant leaves the auxiliary tank in order to go to the propulsion chamber. Thus, in idle mode, there is no need to put the pumps back into operation, and thus no need to make provision for a very strict cooling-down sequence. Degraded cooling down suffices, i.e. cooling down with relaxed target temperatures, and it is even possible to envisage no cooling down at all. This makes it possible to save propellant, time, and energy.

In addition, there is also no need to implement settling prior to feeding the propulsion chamber with propellant coming from the auxiliary tank. Since the auxiliary tank is filled mainly with propellant in the liquid state, no operation is needed to ensure that the fluid traveling along the auxiliary feed pipe to the propulsion chamber is mainly propellant in the liquid state.

In the present application, the “liquid” state and the “gaseous” state should be understood broadly, and covering the supercritical state. By extension, a fluid in the supercritical state is said to be liquid if it is of relatively high density and gaseous if it is of relatively low density. Likewise, the terms “vaporized” and “condensed” may be applied to a supercritical fluid to designate respectively a reduction and an increase in its density, even if there is no change of state proper. Finally, “vaporizing” may designate passing from the liquid state to the gaseous state proper via the supercritical state, and likewise “condensing” may designate passing from the gaseous state to the liquid state proper while passing via the supercritical state.

The feed device of the present invention thus makes it possible at any time to feed the propulsion chamber with propellant in simple manner, and in particular to supply a speed increment in a manner that is simple and inexpensive without overdimensioning the pressurizer system. Since the propellant contained in the auxiliary tank is confined until it is used, there is no need to provide surplus propellant that would be wasted (e.g. de-gassed hydrogen or surplus oxygen for thermal inertia). For these reasons in particular, and in spite of the weight of the auxiliary tank, the feed device of the present invention makes it possible to lighten a propulsion assembly significantly.

Instead of being used for de-orbiting, the speed increment supplied by the auxiliary tank could be used to impart acceleration to the feed device that acts by inertia to press liquid propellant against the bottom of the main tank at the location where the main tank is connected to the main feed pipe. In this way, the auxiliary tank may constitute a settling kit for the main tank, while the auxiliary tank itself does not require any settling in order to operate. Other applications for the feed device of the invention are naturally possible; for example, the auxiliary tank may provide a speed increment for changing orbit, in particular for passing from an elliptical orbit to a circular orbit (circularization operation).

Furthermore, it is naturally possible to provide a plurality of auxiliary tanks, each associated with a respective auxiliary feed pipe having an auxiliary feed valve, with each auxiliary tank being dedicated to a particular use.

In certain embodiments, the auxiliary tank is situated inside the main tank. In this way, the auxiliary tank is protected from solar radiation by the outer shell of the main tank. If no thermal protection is provided for the auxiliary tank, then the propellant contained in the main tank can serve to maintain the temperature of the propellant contained in the auxiliary tank. The auxiliary tank may be attached inside the main tank, in particular using thermally-insulating spacers in order to limit heat exchanges by conduction with the wall of the main tank. Finally, from a safety point of view, positioning the auxiliary tank inside the main tank serves to limit significantly the consequences of any leak from the auxiliary tank, insofar as such a leak would have no consequence other than making the auxiliary tank inoperative, without any risk of propellant leaking out from the main tank.

In certain embodiments, the auxiliary tank is connected by a filler pipe to the main feed pipe upstream from the main feed valve, and the filler pipe includes a filler valve. In such embodiments, it is particularly easy to perform initial filling of the auxiliary tank. With the main feed valve closed, the propellant used for feeding the main tank flows along the main feed pipe from the main tank to the main feed valve. It then suffices to open the filler valve to enable the propellant to penetrate into the filler pipe and fill the auxiliary tank so as to equalize pressure between the main tank and the auxiliary tank. Once the auxiliary tank has been filled, the filler valve can be closed.

In certain embodiments, the feed device further includes a pressurizer pipe for pressurizing the auxiliary tank connecting the auxiliary tank to a main pressurizer pipe. By way of example, the main pressurizer pipe may be a pipe for pressurizing the main tank. The auxiliary pressurizer pipe serves to send a flow of pressurizer fluid for causing the content of the auxiliary tank to flow along the auxiliary feed pipe in idle mode. The pressurizer fluid may be vaporized propellant (this is referred to as “autogenous” pressurization), or it may be an inert gas, e.g. helium (for all propellants) or nitrogen (for all propellants other than LH₂). Furthermore, if the initial pressure of the auxiliary tank is designed to be sufficiently high (e.g. higher than one bar, in particular higher than five bars, specifically higher than ten bars), it is possible to obtain a good flow of propellant in the auxiliary feed pipe without any need to pressurize the auxiliary tank.

In certain embodiments, the capacity of the auxiliary tank is less than the capacity of the main tank. Thus, where appropriate, it is possible for the auxiliary tank to be received inside the main tank without significantly increasing its size. Furthermore, pressurizing it consumes little pressurizer fluid. In particular, in certain embodiments, the capacity of the auxiliary tank is less than 5% of the capacity of the main tank. Thus, the auxiliary tank has sufficient capacity for the above-mentioned applications and it is dimensioned to be as small as possible so as to optimize the weight of the feed device.

In certain applications, the feed device feeds the propulsion chamber with a cryogenic propellant.

The present description also relates to a propulsion assembly comprising at least one rocket engine propulsion chamber and a feed device as described above for feeding the propulsion chamber with at least one propellant.

The present description also relates to a method of feeding at least one rocket engine propulsion chamber with at least one propellant, the method being characterized in that it comprises:
closing a main feed valve to stop the flow of propellant in a main feed pipe connecting a main propellant tank to the propulsion chamber; and
opening an auxiliary feed valve for enabling propellant to flow from an auxiliary tank to the propulsion chamber, the auxiliary tank being connected to the main feed pipe downstream from the main feed valve via an auxiliary feed pipe provided with said auxiliary feed valve.

Such a feed method possesses numerous applications, as explained above. In particular, it makes it possible to de-orbit a space launcher stage or to settle a main tank, while overcoming the drawbacks of feed methods making use of state of the art devices.

In certain embodiments, the method further includes pressurizing the auxiliary tank before and/or after opening the auxiliary feed valve.

This pressurizing can be useful if the pressure of the auxiliary tank is not high enough initially and throughout the entire duration of the engine operating in idle mode.

### BRIEF DESCRIPTION OF THE DRAWINGS

The invention and its advantages can be better understood on reading the following detailed description of embodiments given as non-limiting examples. The description refers to the accompanying drawings, in which:

FIG. 1 shows a propulsion assembly including a feed device in a first embodiment;

FIG. 2 shows a propulsion assembly including a feed device in a second embodiment; and

FIG. 3 shows a propulsion assembly including a feed device in a third embodiment.

### DETAILED DESCRIPTION OF THE INVENTION

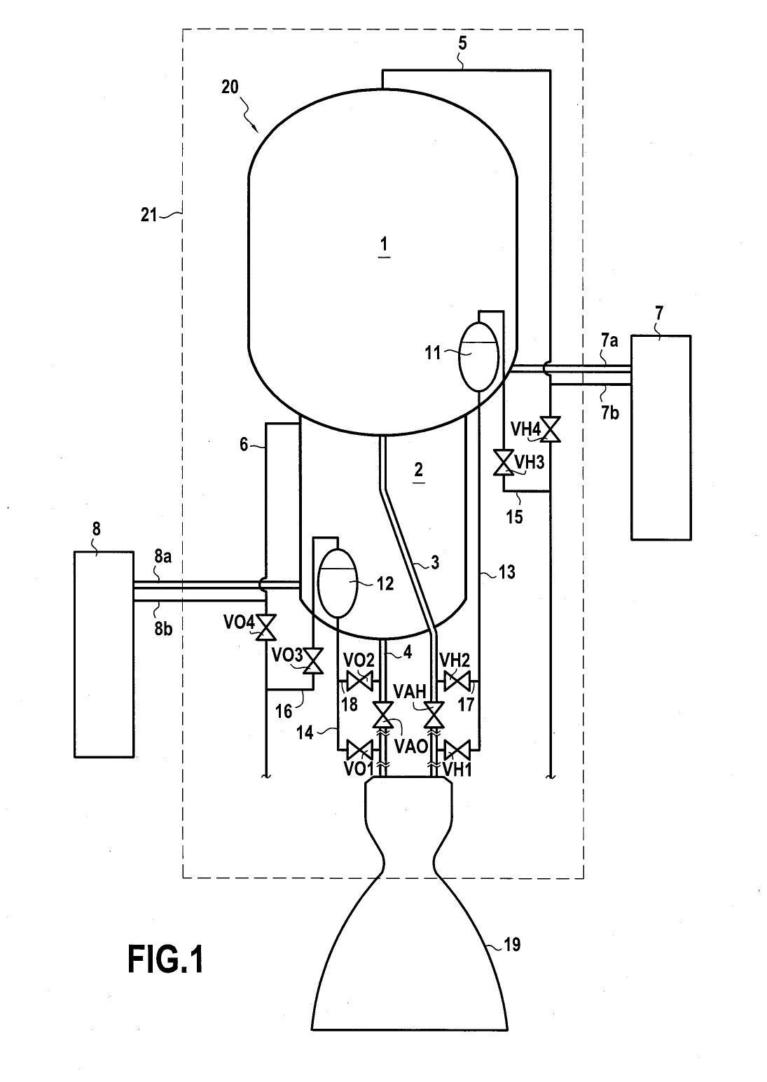

More precisely, FIG. 1 shows a propulsion assembly 21 comprising a propulsion chamber 19 and a feed device 20 for feeding the propulsion chamber 19 with two propellants. Specifically, the propulsion assembly 21 may be a top stage of a space launcher, however other types of propulsion assembly may be envisaged. In the embodiment described, the propellants are cryogenic propellants, and more particularly liquid hydrogen (LH₂) and liquid oxygen (LOx). In a variant, liquid methane (LCH₄) could be used instead of liquid hydrogen. The feed device described below may naturally feed the propulsion chamber with any number of propellants, without necessarily including liquid hydrogen or liquid oxygen.

The feed device 20 comprises a main hydrogen tank 1, a first main feed pipe 3 extending between the main hydrogen tank and the propulsion chamber 19, and a first main feed valve VAH placed on the first main feed pipe 3. A first main pressurizer pipe 5 is connected to the main hydrogen tank 1 in order to pressurize the main hydrogen tank. The first main pressurizer pipe 5 is provided with a first main pressurizer valve VH4. Furthermore, when the propulsion assembly 21 is on the ground, prior to launch, the main hydrogen tank 1 may be connected to a first external feed (e.g. a valve plate) 7 in order to feed it with propellant and pressurize it. In the embodiment described, the main hydrogen tank 1 is fed with propellant and pressurized from the valve plate 7 respectively via two pipes 7a and 7b. The pressurizer fluid may be a gas that is inert relative to hydrogen, and in particular a gas having a lower liquefaction temperature at ambient pressure than hydrogen, e.g. helium. In another embodiment, it would be possible to have only one pipe 7a for feeding the main hydrogen tank 1 with hydrogen, with pressure being provided by vaporizing a fraction of the hydrogen supplied to said tank 1.

The feed device 20 also has a main oxygen tank 2, a second main feed pipe 4 extending between the main oxygen tank and the propulsion chamber 19, and a second main feed valve VAO placed on the second main feed pipe 4. A second main pressurizer pipe 6 is connected to the main oxygen tank 2 to pressurize the main oxygen tank. The second main pressurizer pipe 6 is provided with a second main pressurizer valve VO4. Furthermore, when the propulsion assembly 21 is on the ground, prior to launch, the main oxygen tank 2 may be connected to a second external feed (e.g. a valve plate) 8 for feeding it with propellant and for pressurizing it. In the embodiment described, the main oxygen tank 2 is fed with propellant and pressurized from the valve plate 8 respectively via two pipes 8a and 8b. The pressurizer fluid may be a gas that is inert relative to oxygen, and in particular a gas having a lower liquefaction temperature at ambient temperature than oxygen, e.g. nitrogen or helium. In another embodiment, it would be possible to have only one pipe 8a for feeding the main oxygen tank 2 with oxygen, with pressurizing being performed by vaporizing a fraction of the oxygen supplied to said tank 2.

In the embodiment described, the main hydrogen and oxygen tanks 1 and 2 have an end wall in common, thereby leading to exchanges of heat between the two propellants, specifically heating of the hydrogen and cooling of the oxygen. With two main tanks that are separate, such heat exchanges become negligible, but both propellants are nevertheless heated because of solar radiation. The invention relates to both types of feed device; adapting the feed device described to the situation in which the main tanks are separate is within the competence of the person skilled in the art and is not described in detail below.

As shown in FIG. 1, the feed device 20 includes an auxiliary hydrogen tank 11 of capacity that is smaller than the capacity of the main hydrogen tank 1. The auxiliary hydrogen tank 11 is placed inside the main hydrogen tank 1. The feed device also has a first auxiliary feed pipe 13 connecting the auxiliary hydrogen tank 11 to the first main feed pipe 3 downstream from the first main feed valve VAH, and a first auxiliary feed valve VH1 placed on the first auxiliary feed pipe 13.

Certain known elements of the feed device 20 are not shown, and in particular as indicated in FIG. 1, elements that are located on the first main feed pipe 3 between the first main feed valve VAH and the propulsion chamber 19. At this location, the first main feed pipe 3 may in particular pass through one or more pumps enabling the propulsion chamber 19 to be fed with hydrogen coming from the main hydrogen tank 1. The first auxiliary feed pipe 13 may connect the auxiliary hydrogen tank 11 to the first main feed pipe 3 upstream or downstream from said pump. More generally, the first auxiliary feed pipe 13 may connect the auxiliary hydrogen tank 11 to the first main feed pipe 3 at several locations of said first main pipe 3, providing that remains downstream from the first main feed valve VAH.

A first auxiliary pressurizer pipe 15 connects the auxiliary hydrogen tank 11 to the first main pressurizer pipe 5 upstream from the first main pressurizer valve VH4, in order to pressurize the auxiliary hydrogen tank 11. The first auxiliary pressurizer pipe is provided with a first auxiliary pressurizer valve VH3. The auxiliary hydrogen tank 11 can thus be pressurized directly via the first main pressurizer pipe 5 and then the first auxiliary pressurizer pipe 15 without requiring an additional source of pressurizer fluid.

In addition, a first filler pipe 17 extends between the first main feed pipe 3 upstream from the first main feed valve VAH and the auxiliary hydrogen tank 11. The first filler pipe is provided with a first filler valve VH2. In the embodiment shown, the first auxiliary feed pipe 13 and the first feed pipe 17 have a segment in common.

Optionally, one or more valves selected from the first auxiliary feed valve VH1, the first filler valve VH2, and the first auxiliary pressurizer valve VH3 are placed as close as possible to the auxiliary hydrogen tank 11 in order to minimize heat losses.

In analogous manner, and as shown in FIG. 1, the feed device 20 has an auxiliary oxygen tank 12 of capacity that is less than the capacity of the main oxygen tank 2. The auxiliary oxygen tank 12 is placed inside the main oxygen tank 2. The feed device also has a second auxiliary feed pipe 14 connecting the auxiliary oxygen tank 12 to the second main feed pipe 4 downstream from the second main feed valve VAO, and a second auxiliary feed valve VO1 placed on the second auxiliary feed pipe 14.

Certain known elements of the feed device 20 are not shown, in particular and as indicated in FIG. 1, elements that are located on the second main feed pipe 4 between the second main feed valve VAO and the propulsion chamber 19. At this location, the second main feed pipe 4 may in particular pass through one or more pumps enabling the propulsion chamber 19 to be fed with oxygen coming from the main oxygen tank 2. The second auxiliary feed pipe 14 may connect the auxiliary oxygen tank 12 to the second main feed pipe 4 upstream or downstream from said pump. More generally, the second auxiliary feed pipe 14 may connect the auxiliary hydrogen tank 12 to the second main feed pipe 4 at a plurality of locations of said second main pipe 4, providing that it remains downstream from the second main feed valve VAO.

A second auxiliary pressurizer pipe 16 connects the auxiliary oxygen tank 12 to the second main pressurizer pipe 6 upstream from the second main pressurizer valve VO4 in order to pressurize the auxiliary oxygen tank 12. The second auxiliary pressurizer pipe is provided with a second auxiliary pressurizer valve VO3. The auxiliary oxygen tank 12 can thus be pressurized directly via the second main pressurizer pipe 6 and then the first auxiliary pressurizer pipe 16 without requiring an additional source of pressurizer fluid.

Furthermore, a second filler pipe 18 extends between the second main feed pipe 4 upstream from the second main feed valve VAO and the auxiliary oxygen tank 12. The second filler pipe is provided with a second filler valve VO2. The auxiliary oxygen tank can thus be pressurized directly by the pressurizer system of the top stage without requiring an auxiliary pressurizer system. In the embodiment shown, the second auxiliary feed pipe 14 and the second filler pipe 18 have a segment in common.

Optionally, one or more valves selected from the second auxiliary feed valve VO1, the second filler valve VO2, and the second auxiliary pressurizer valve VO3 are placed as close as possible to the auxiliary oxygen tank 12 in order to minimize heat losses.

In the present embodiment, the auxiliary tanks 11 and 12 are small in size and substantially cylindrical in shape, so as to make them easy to insert in the main tanks 1 and 2. Furthermore, the auxiliary tanks 11 and 12 do not have any thermal protection so as to have their temperatures maintained by the propellants sloshing in the main tanks 1, 2.

There follows a description of the operation of the feed device in this embodiment relative to the main steps of a mission for putting a payload into orbit. The description below describes only the operation of the device for feeding the propulsion chamber 19 with hydrogen. Unless mentioned to the contrary, all of the explanations concerning elements relating to hydrogen can be applied equally to the corresponding elements relating to oxygen. Variants may naturally be provided depending on the objectives of the person skilled in the art.

On the ground, before starting the propulsion assembly, the feed device 20 is filled as follows: the valves VH1, VH2, and VAH are closed while the valves VH3 and VH4 are opened. The valve plate 7 is connected to the main hydrogen tank 1 and feeds the main hydrogen tank 1 with liquid hydrogen. Liquid hydrogen thus penetrates into the main hydrogen tank and then into the first main feed pipe 3 until it reaches the first main feed valve VAH, which is closed. Thus, the hydrogen contained in the main hydrogen tank 1 can cool the auxiliary hydrogen tank from the outside. Thereafter, when the auxiliary hydrogen tank is sufficiently cold, or when the hydrogen in the tank 1 reaches a certain level, the first filler valve VH2 is opened and hydrogen can continue to flow along the first filler pipe 17 into the auxiliary hydrogen tank 11. In this way, the auxiliary hydrogen tank 11 is filled merely by equalizing pressures in these two tanks 1 and 11. The fact that the main and auxiliary pressurizer valves VH3 and VH4 are open enables hydrogen vapor to be degassed, and thus enables the pressure in these two tanks 1 and 11 to be controlled. A level detector (not shown) in the auxiliary hydrogen tank 11 makes it possible to stop filling the auxiliary hydrogen tank 11, e.g. by closing the first filler valve VH2, once the level of hydrogen in this tank has reached a desired level.

It is preferable not to fill the auxiliary hydrogen tank 11 completely in order to leave a volume of pressurizer fluid (e.g. helium, nitrogen, or vaporized hydrogen) for the purpose of accommodating pressure variations in the event of a change of temperature in the liquid hydrogen. This volume may be about 5% of the capacity of the auxiliary hydrogen tank 11. Preferably, since hydrogen tends to vaporize because of heat exchange with the hotter oxygen and with solar radiation, said volume of pressurizer fluid is designed for under-pressure in the auxiliary hydrogen tank 11; conversely, when the main tanks share a wall in common, since oxygen tends to liquefy because of heat exchange with colder hydrogen, the volume of pressurizer fluid in the auxiliary oxygen tank 12 may be designed for over-pressure.

Since the auxiliary hydrogen tank 11 is filled almost entirely, there may be no need to provide an anti-sloshing device inside it, and if this is true that represents a saving in terms of on-board weight. Once filling of the auxiliary hydrogen tank 11 has come to an end, the filling of the main hydrogen tank 1 may possibly continue, in ways well known to the person skilled in the art.

While the rocket engine is operating at nominal speed, the first auxiliary valves VH1, VH2, and VH3 are closed, such that the rocket engine operates as though it did not have an auxiliary hydrogen tank. This operation is well known to the person skilled in the art and is therefore not described in detail herein.

In order to release the payload, the rocket engine is shut down and the propulsion assembly 21 follows a ballistic trajectory. The first auxiliary valves VH1, VH2, and VH3, and also the first main feed valve VAH are closed, while the first main pressurizer valve VH4 is opened. Thus, operation continues, likewise as though there were no auxiliary hydrogen tank.

During the ballistic trajectory, the main hydrogen tank 1 contains little hydrogen, since most of the hydrogen that it contained has been consumed. Likewise, the main oxygen tank 2 contains little oxygen. Consequently, there is very little heat exchange between the auxiliary hydrogen tank 11 and the auxiliary oxygen tank 12, such that each of the propellants contained in these two auxiliary tanks 11 and 12 is at a temperature that is relatively stable. Consequently, the heating and vaporizing of the hydrogen contained in the auxiliary hydrogen tank 11 are very limited, and the cooling of the oxygen contained in the auxiliary oxygen tank 12 is likewise very limited.

The need to make provision when dimensioning the auxiliary tanks 11 and 12 for a quantity of propellant that is to be degassed (for hydrogen) or that is to provide thermal inertia (for oxygen) is thus greatly reduced, or even eliminated.

In parallel, the propellants that remain in the main tanks 1 and 2 are of no further use from a propulsion point of view once the ballistic trajectory has begun. In particular, since the main tanks 1 and 2 are not used for the de-orbiting maneuver, there is no need to provide for reserves of hydrogen or oxygen in these tanks. On the contrary, it is even possible for the main tanks 1 and 2 to be emptied in order to further reduce the above-mentioned heat exchanges between the auxiliary tanks 11 and 12.

Once the payload has been put into orbit, the propulsion assembly 21 needs to be de-orbited in order to avoid becoming orbital debris. This step is performed by making the rocket engine operate in idle mode without using dedicated additional nozzles. In the embodiment described, for this idle mode, the first main feed valve VAH and the first main pressurizer valve VH4 are closed, as is the first filler valve VH2. Consequently, the main hydrogen tank 1 is isolated from the remainder of the feed device 20. The first auxiliary feed valve VH1 and the first auxiliary pressurizer valve VH3 are opened.

Since the first main pressurizer valve VH4 is closed in order to enable pressure in the first auxiliary tank 11 to be controlled, the pressure in the main hydrogen tank 1 is no longer controlled. However, the remaining hydrogen may vaporize in part. This problem can be solved, by way of example, by providing the main hydrogen tank 1 with a pressure release device or by emptying the main hydrogen tank 1 before beginning idle mode.

The liquid hydrogen contained in the auxiliary hydrogen tank 11 flows to the main propulsion chamber 19 via the first auxiliary feed pipe 13, mainly under the effect of the pressure difference between the auxiliary hydrogen tank 11 and the propulsion chamber 19. In the present embodiment, no pump is provided for causing the hydrogen to flow from the auxiliary hydrogen tank 11 to the propulsion chamber 19 of the rocket engine. If the pressure difference is not great enough, it may be increased by pressurizing the auxiliary hydrogen tank 11 via the first auxiliary pressurizer pipe 15.

If pressurizing the auxiliary hydrogen tank 11 is necessary, that consumes much less pressurizer fluid than would be consumed pressurizing the main hydrogen tank 1, which is much larger and at this stage of the mission is almost empty, whereas the auxiliary hydrogen tank 11 is small and almost full when the engine begins to operate in idle mode. The use of an auxiliary hydrogen tank makes a significant saving in weight possible because of the saving in pressurizer fluid (e.g. helium) together with the associated tanks and lines, and because of the saving in non-consumable propellants in the main tanks (evaporated or residual propellants). In return, the dry weight of the auxiliary hydrogen tank 11 is smaller. By way of example, when a feed device of the invention is used for each propellant, as applies to hydrogen and oxygen in the embodiment shown in FIG. 1, the resulting saving in weight is of the order of several hundreds of kilograms. Thus, for the feed device of the invention, the additional dry weight needed for providing the propulsion assembly with the ability to de-orbit increases little compared with a feed device that does not make provision for de-orbiting, and the saving in weight is considerable relative to a feed device that provides for de-orbiting using one of the techniques known in the prior art.

Feeding the propulsion chamber 19 with propellants in idle mode serves to impose a speed increment. In idle mode, thrust is about one hundred times less than the nominal thrust of the engine. The speed increment obtained by using the engine in idle mode for several tens or hundreds of seconds nevertheless suffices to de-orbit the propulsion assembly 21. In addition, although the feed device 20 is described in a de-orbiting application, its structure is generic and suitable for other idle-mode applications, such as for example settling the main tanks 1, 2 or circularizing the orbit being followed.

Another application is also possible, which application consists in using the auxiliary tanks 11 and 12 during operation in idle mode in order to increase the accuracy with which the payload is released (e.g. a satellite). The low thrust associated with idle mode makes it possible, after operating in nominal mode, to refine the trajectory of the propulsion assembly 21 while it is still assembled with the payload. By means of the feed device 20, this can be done without repressurizing the main tanks 1 and 2.

Furthermore, given the small size of the auxiliary tanks 11 and 12, it is possible to increase the pressure to which the auxiliary tanks 11 and 12 are pressurized to five bars or ten bars or even more, so that the pressure of the propellants injected into the propulsion chamber 19 is greater without that being too penalizing for the weight of the feed device 20. Two advantages of such a variant are firstly the possibility of injecting propellants at high pressure into the propulsion chamber 19 in idle mode even though the pumps are stopped, thereby decreasing the consumption of the engine, and thus decreasing the weight of propellant needed for de-orbiting the propulsion assembly 21, with a greater speed increment for de-orbiting; and secondly the possibility of limiting or even completely omitting feeding the auxiliary tanks 11 and 12 with pressurizer fluid while they are being emptied to the propulsion chamber 19. This is referred to as operating in “blow down” mode.

With reference particularly to the de-orbiting maneuver, the instant at which the speed increment is imparted is the result of a compromise: firstly, the later the de-orbiting instant (i.e. the closer the stage is to the apogee of its orbit), the smaller the speed increment that needs to be supplied; secondly, the later the instant of de-orbiting, the greater the amount of heat exchange that takes place between the propellants, and thus the smaller the amount of usable propellants that will be available in the tanks supplying said propellants. The way heat exchange involving the auxiliary tanks 11 and 12 is minimized (since they are neither exposed to the sun nor in contact with each other), thus makes it possible to wait for longer before imparting the speed increment, and thus to impart a speed increment that is smaller. This ends up making it possible for the dimensions of the auxiliary tanks 11 and 12 to be even smaller.

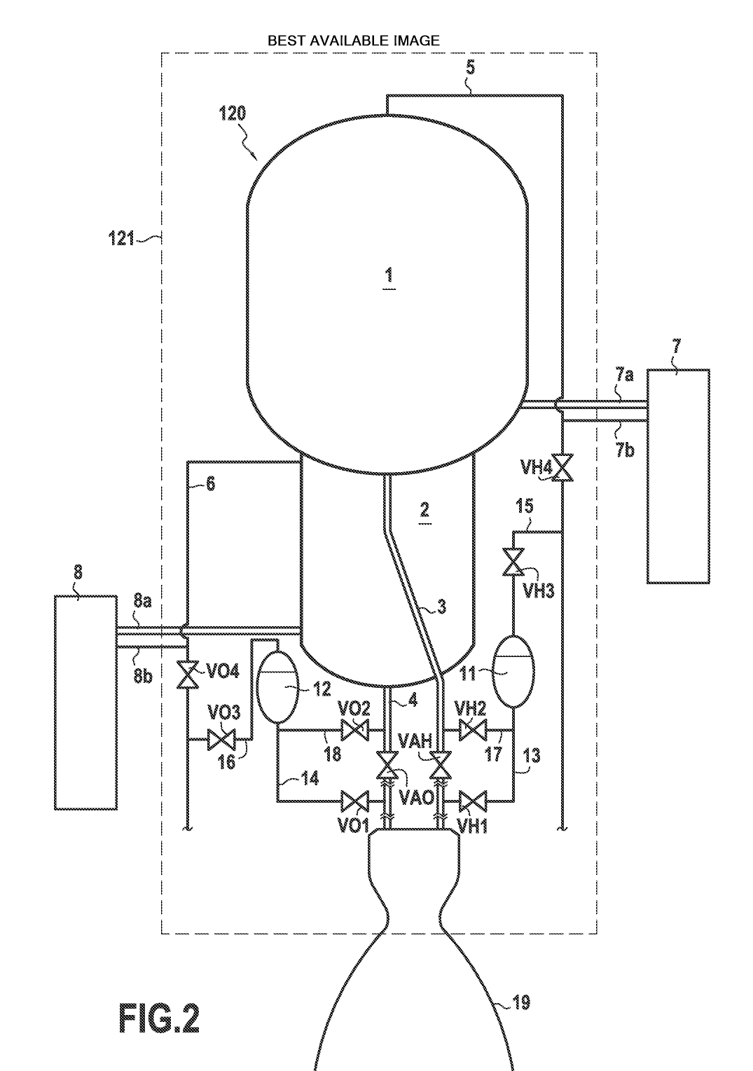

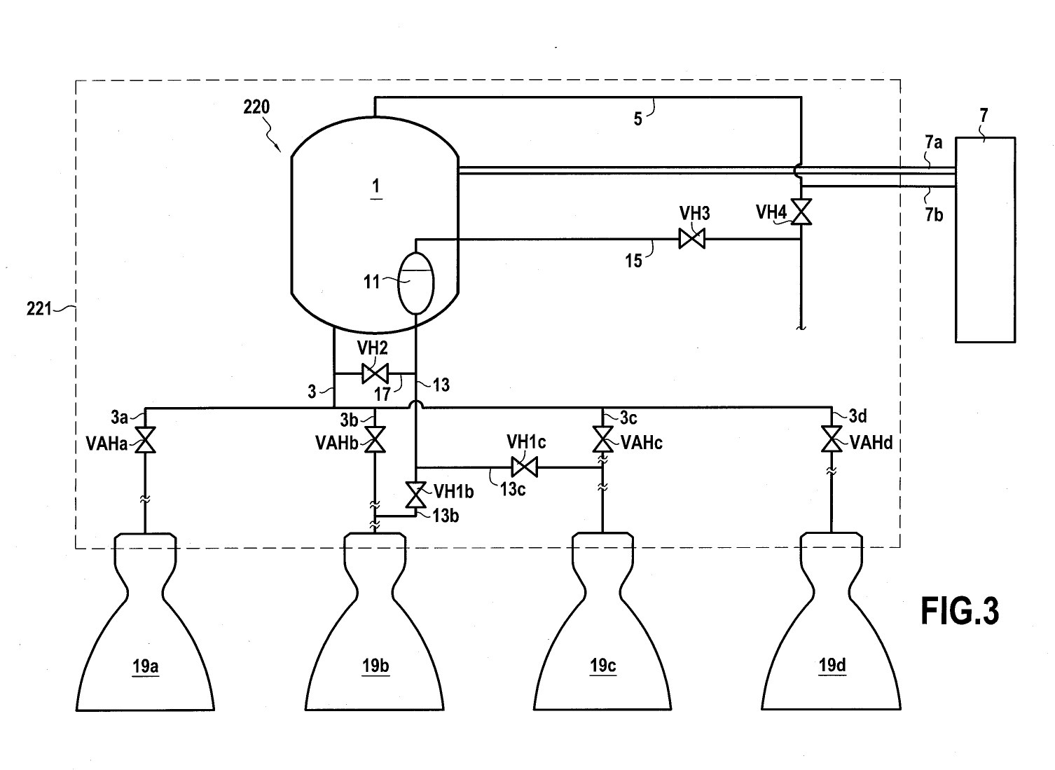

FIGS. 2 and 3 show the propulsion assembly in other embodiments. In these figures, elements corresponding or identical to elements of the first embodiment are given the same reference signs and are not described again.

FIG. 2 shows a propulsion assembly 121 in a second embodiment. The propulsion assembly 121 is identical to the propulsion assembly 21 of the first embodiment, except that the auxiliary tanks 11 and 12 are situated respectively outside the corresponding main tanks 1 and 2.

FIG. 3 shows a propulsion assembly 221 in a third embodiment. The propulsion assembly 221 has four propulsion chambers 19a, 19b, 19c, and 19d fed with propellant by a feed device 220. There could be any number of propulsion chambers. For reasons of clarity, FIG. 3 shows the feed to the propulsion chambers 19a, 19b, 19c, and 19d for only the propellant contained in a single main tank 1, however the propulsion chambers 19a, 19b, 19c, and 19d can be fed with a plurality of propellants, as described for the above embodiments.

In this third embodiment, the main feed pipe 3 is split into four main feed sub-pipes 3a, 3b, 3c, and 3d, each having a respective main feed valve VAHa, VAHb, VAHc, VAHd and each feeding a respective one of the propulsion chambers 19a, 19b, 19c, 19d.

The feed device 220 also has the auxiliary tank 11 from which the auxiliary feed pipe 13 extends. The auxiliary feed pipe 13 is split into two auxiliary feed sub-pipes 13b and 13c each having a respective auxiliary feed valve VH1b, V1Hc, and each connected to the respective main feed sub-pipes 3b, 3c downstream from the main feed valves VAHb, VAHc. Thus, the auxiliary tank 11 can act via the auxiliary feed pipe 13 and the auxiliary feed sub-pipes 13b and 13c to feed the two propulsion chambers 19b and 19c. In other embodiments, the auxiliary tank 11 could feed some or all of the propulsion chambers.

Because of the main feed valves VAHb, VAHc and the auxiliary feed valves VH1b, VH1c, each propulsion chamber 19b, 19c can be fed from the auxiliary tank 11 under control that is independent from the control of the other propulsion chambers. The feed device 220 can thus have numerous applications for its use, while conserving the advantages described with reference to the first embodiment.

In the embodiments described, pressure in the main hydrogen tank 1 is described as being controlled with the help of the main pressurizer valve VH4. Nevertheless, pressure control could be performed with the help of some other valve (not shown), and in particular a valve placed on a branch pipe (not shown) connected to the main pressurizer pipe 5 between the main hydrogen tank 1 and the main pressurizer valve VH4. By way of example, such another valve may form part of the roll and attitude control system (RACS) of the propulsion assembly. In addition, the RACS may be provided with a purge line, e.g. enabling the main hydrogen tank 1 to be emptied and/or de-gassed.

Although the present invention is described with reference to specific embodiments, modifications may be made to those embodiments without going beyond the general ambit of the invention as defined by the claims. In particular, individual characteristics of the various embodiments shown and/or described may be combined in additional embodiments. Consequently, the description and the drawings should be considered in a sense that is illustrative rather than restrictive.

1. A feed device for feeding at least one rocket engine propulsion chamber with propellant, the feed device comprising a main propellant tank, a main feed pipe extending from the main tank for feeding the propulsion chamber, and having a main feed valve placed thereon, the feed device further comprising an auxiliary tank for said propellant and an auxiliary feed pipe provided with an auxiliary feed valve connecting the auxiliary tank to the main feed pipe downstream from the main feed valve, wherein the auxiliary tank is situated inside the main tank.

2. A feed device according to claim 1, wherein the auxiliary tank is connected by a filler pipe to the main feed pipe upstream from the main feed valve, and the filler pipe includes a filler valve.

3. A feed device according to claim 1, further including a pressurizer pipe for pressurizing the auxiliary tank connecting the auxiliary tank to a main pressurizer pipe.

4. A feed device according to claim 1, wherein the capacity of the auxiliary tank is less than the capacity of the main tank.

5. A feed device according to claim 4, wherein the capacity of the auxiliary tank is less than 5% of the capacity of the main tank.

6. A feed device according to claim 1, for feeding the propulsion chamber with a cryogenic propellant.

7. A propulsion assembly comprising at least one rocket engine propulsion chamber and a feed device according to claim 1 for feeding the propulsion chamber with at least one propellant.

8. A method of feeding at least one rocket engine propulsion chamber with at least one propellant, the method being characterized in that it comprises:
closing a main feed valve to stop the flow of propellant in a main feed pipe extending from a main propellant tank to the propulsion chamber; and
opening an auxiliary feed valve for enabling propellant to flow from an auxiliary tank situated inside the main tank to the propulsion chamber, the auxiliary tank being connected to the main feed pipe downstream from the main feed valve via an auxiliary feed pipe provided with said auxiliary feed valve.

9. A feed method according to claim 8, further including pressurizing the auxiliary tank before and/or after opening the auxiliary feed valve.
